(19) United States
(12) Patent Application Publication
(10) Pub. No.: US 2011/0290744 A1
(43) Pub. Date: Dec. 1, 2011

(54) Wastewater Treatment System and Method

(76) Inventor: Elwin Leroy Faulk, JR., Longville, LA (US)

(21) Appl. No.: 13/118,963

(22) Filed: May 31, 2011

Related U.S. Application Data
(60) Provisional application No. 61/350,175, filed on Jun. 1, 2010.

(51) Int. Cl. C02F 1/00; B01D 35/30

(52) U.S. Cl. 210/806; 210/252; 210/232

(57) ABSTRACT

A wastewater treatment system includes a vessel and a plurality of media canisters contained in series therein. The vessel provides for linear flow of wastewater through the canisters for treating and removing contaminants. The canisters contain seal means to form a fluid tight seal against the inner wall of the vessel. The linear flow provides for increased flow rates and more efficient treatment and removal of contaminants. A method of using the treatment system to treat wastewater to remove or neutralize one or more contaminants therein is also described.

### CROSS-REFERENCE TO RELATED APPLICATIONS

This application claims priority to Provisional Application No. 61/350,175, filed on Jun. 1, 2010, which is incorporated herein by reference.

### BACKGROUND OF THE INVENTION

The present invention relates to wastewater treatment systems and methods, and more particularly to oilfield wastewater treatment systems and methods.

Wastewater is often a by-product of oil and gas operations, transportation, or storage. The wastewater may contain impurities such as hydrocarbons, solids, toxic materials, and other contaminants. These impurities must be removed from the wastewater before the water may be disposed of or reused. Radial flow wastewater treatment tanks have been developed to remove the impurities from wastewater. Radial flow treatment tanks employ radial flow non-ferrous canisters that contain media capable of removing (e.g., by adsorption) or neutralizing the impurities.

Despite the development of radial flow wastewater treatment systems, the need still exists for a wastewater treatment system that achieves higher flow rates and greater efficiencies.

### SUMMARY OF THE INVENTION

It is an object of the present invention to provide a wastewater treatment system and method that achieves a linear flow.

It is a further object of the present invention to provide a wastewater treatment system and method that achieves higher flow rates.

It is a further object of the present invention to provide a wastewater treatment system and method that achieves greater efficiencies.

It is a further object of the present invention to provide a wastewater treatment system and method that achieves more efficient contact between the wastewater and the treatment media.

It is a further object of the present invention to provide a wastewater treatment system and method that enables the application of a variety of treatment media.

These and other objects and advantages of the present invention are provided by the novel wastewater treatment system described herein. The system may include a vessel having an inlet end, an outlet end, and an inner compartment with an inner wall. The system may also include a plurality of media canisters. The canisters may be housed within the inner compartment of the vessel and in linear fluid communication with each other. Each of the media canisters may contain a bulk treatment media. Each of the canisters may include a seal means forming a fluid tight seal between the canister and the inner wall of the vessel.

A feature of the present invention is the capability for linear, as opposed to radial, flow of the wastewater within the vessel. Linear flow of wastewater may be accomplished under greater fluid pressures and at higher flow rates.

Another feature of the present invention is the ability to mix and match various bulk treatment media within a single vessel via the use of more than one canister.

### BRIEF DESCRIPTION OF THE DRAWINGS

FIG. 1 is a cutaway side view of an embodiment of the present invention.

FIG. 2 is a perspective side view of an embodiment of a media canister of the present invention.

FIG. 3 is a perspective front view of the embodiment of the canister of the present invention of FIG. 2.

FIG. 4 is a isometric front side view of another embodiment of the present invention.

FIG. 5 is an isometric side view of the embodiment of the present invention shown in FIG. 4 positioned on a trailer for transport.

### DETAILED DESCRIPTION OF THE INVENTION

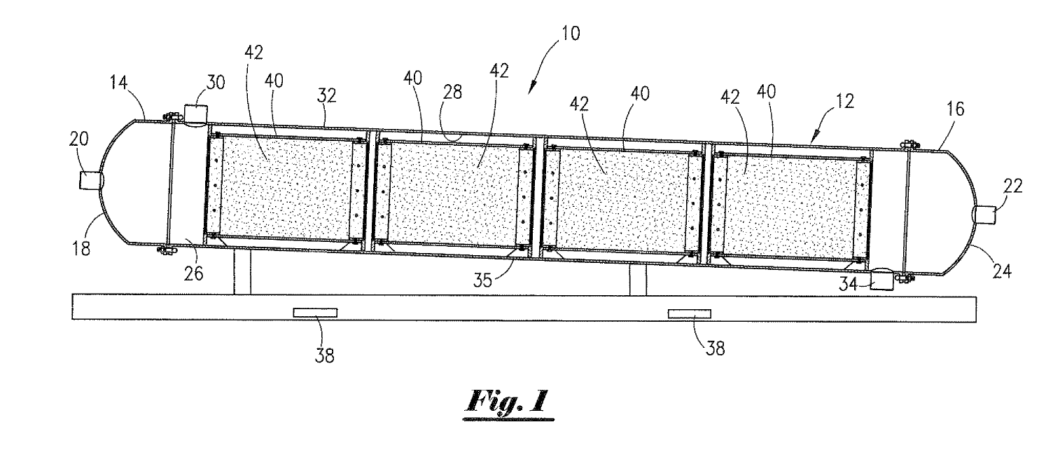

FIG. 1 illustrates wastewater treatment system 10. System 10 may include vessel 12. Vessel 12 may have inlet end 14 and outlet end 16. Inlet end 14 may include inlet end cap 18 with inlet portal 20. A conduit (not shown) may be detachably secured to portal 20 to facilitate fluid communication of wastewater from a wastewater source to vessel 12 for treatment. Outlet end 16 may include outlet end cap 22 with outlet portal 24. A conduit (not shown) may be detachably secured to portal 24 to facilitate fluid communication of treated water from vessel 12 for disposal or other use. Vessel 12 may include interior compartment 26 with inner wall 28. Caps 18 and 22 may be detachably connected to vessel 12 by a variety of means such as bolts, screws, latches, or the like. It is intended that caps 18 and 22 may be removed from vessel 12 to gain access to compartment 26.

Again with reference to FIG. 1, vessel 12 may include air vent 30 for the passage of air from compartment 26 to the atmosphere. Vent 30 is preferably positioned on top side 32 of vessel 12 and more preferably at or near inlet end 14. Vessel 12 may also include drain portal 34 for the passage of contaminant liquids from compartment 26 for collection and disposal. Portal 34 is preferably positioned on bottom side 35 of vessel 12 and more preferably at or near outlet end 16.

FIG. 1 also illustrates that vessel 12 may be detachably or fixedly attached to skid 36. Skid 36 may include forklift pockets 38 for receipt of forklift prongs of a forklift (not shown) so that skid 36 and attached vessel 12 may be lifted and moved from one position to another.

As seen in FIG. 1, vessel 12 is preferably cylindrical or tubular but could be configured in a variety of shapes. Vessel 12 is also preferably positioned horizontally for operational purposes but could be positioned vertically. Vessel 12 may also be positioned horizontally but with a slight angle so that inlet end 14 is positioned slightly higher than outlet end 16. In this configuration, contaminate liquid may be more easily drained from vessel 12 through portal 34. Vessel 12 is preferably made of steel or other hardened metal.

With further reference to FIG. 1, vessel 12 may include media canisters 40. Canisters 40 are positioned within compartment 26 in series (e.g., aligned back-to-back) such that canisters 40 are in fluid communication. Canisters 40 are designed to contain treatment media 42 that treats or removes contaminants from the wastewater that flows through vessel 12. Canisters 40 may each contain the same media 42 or may contain different media 42 depending on the type and/or amount of contaminants within the wastewater to be treated or removed. Types of media 42 that may be used within canisters 40 may include carbon, flocculants, coagulants, organophillic clay media, and/or solidification agents, all of which are well known in the art.

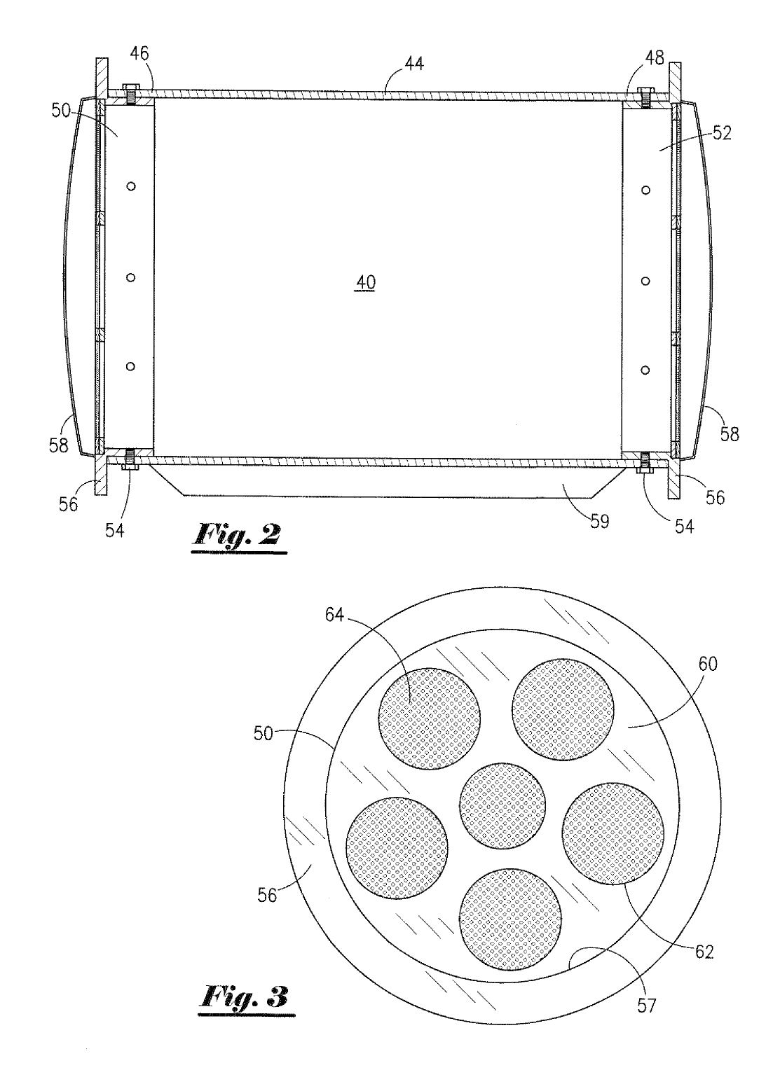

FIG. 2 depicts canister 40. Canister 40 may include bulk media container 44 having a first end section 46 and a second end section 48. Removable end plates 50, 52 may be detachably secured to respective end sections 46, 48. End plates 50, 52 may be detachably secured to respective end sections 46, 48 by any suitable means such as bolts, screws, latches, or the like. Screws 54 are the preferable means to accomplish the removable connection of end plates 50, 52. End plates 50, 52 may include seal means 56 to form a seal between canister 40 and inner wall 28 of vessel 12 when canister 40 is inserted in vessel 12. End plates 50, 52 may also include handling means 58 which may be grasped and pulled to remove canister 40 from vessel 12 or to assist in the removal of end plates 50, 52 from container 44. Handling means 58 may be any type of device that may be grasped such as a strap. Canister 40 also may include one or more skids 59 to facilitate the insertion and removal of canister 40 from vessel 12. Skids 59 may be made of Teflon®.

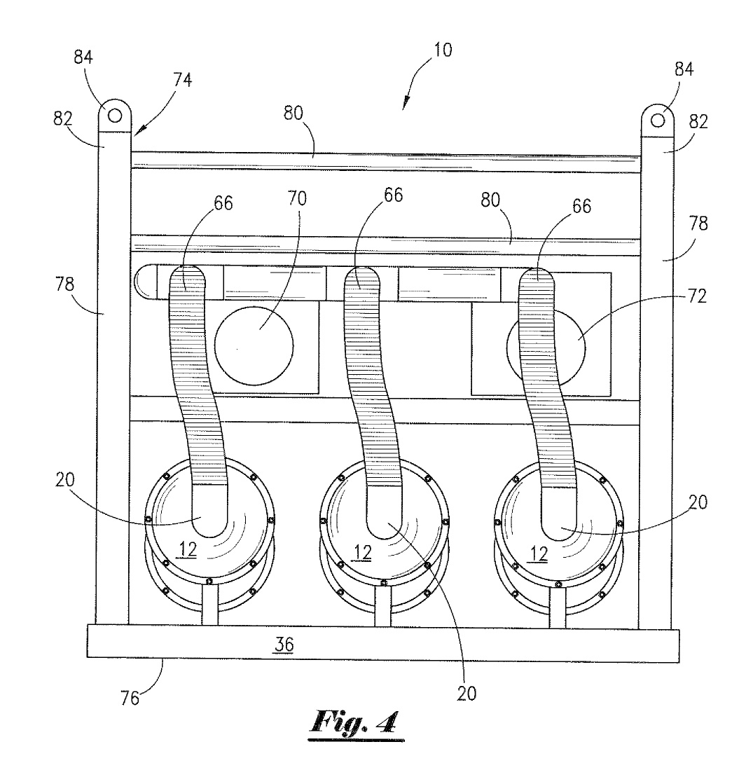

With reference to FIG. 3, end plates 50, 52 may include screen support plate 60 with one or more openings 62 that permit fluid communication into and out of container 44. Plates 50, 52 may also include perforated screen 64 that covers openings 62. Screen 64 contains media 42 within container 44 but permits fluid communication into and out of container 44. FIG. 3 also shows seal means 56 extending around outer edge 57 of end plate 50, 52. Seal means 56 may be composed of any type of material capable of forming a fluid tight seal. Preferably, seal means 56 is a made of an elastomeric material that rolls back when canister 40 is inserted within compartment 26 of vessel 12 to form a positive seal with inner wall 28. Seal means 56 also forms a fluid tight seal between adjacent canister 40 when placed in series (i.e., back-to-back) within vessel 12.

Canisters 40 may be cylindrical or tubular in shape so they may be inserted into vessel 12 that may also be cylindrical or tubular. However, it is to be understood that canisters 40 may be formed in a variety of other shapes. Container 44 may be made of PVC material. Preferably, canisters 40 are made of material that may be disposable so that canisters 40 may be discarded after their use and recycled. End plates 50, 52 may be made of steel or PVC. Canister 40 may be 12 inches by 2 feet; but its dimension may be varied depending on the shape or dimensions of vessel 12 and the desired size of canister 40 or the sizes of seal means 56. It is also to be understood that while a plurality of canisters 40 are described herein, canister 40 could be constructed of a single unit with separate compartments formed therein to house bulk media 42.

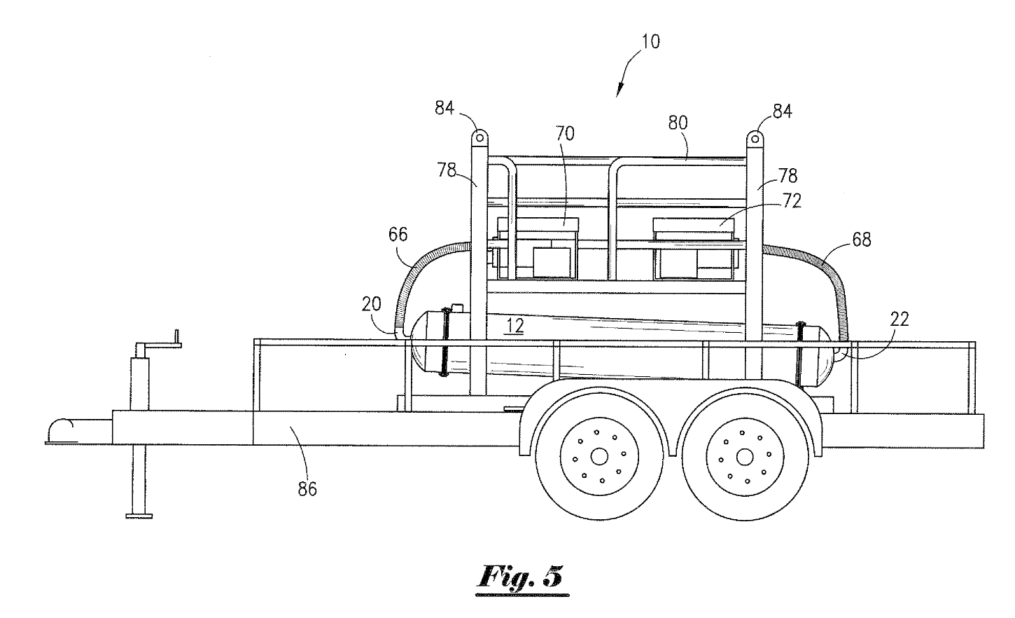

FIGS. 4 and 5 reveal an embodiment of system 10 in which three vessels 12 are positioned on skid 36. Conduits 66 are shown in fluid communication with vessels 12 via inlet portals 20. Conduits 68 are shown in fluid communication with vessels 12 via outlet portals 24. Conduits 66 transport wastewater under pressure to vessels 12. Pump 70 pumps wastewater (via conduits 66) under pressure into and through vessel 12. Pump 72 is option and may be included as a back-up pump for pump 70.

While the embodiment shown in FIGS. 4 and 5 contains three vessels 12, it is to be understood that a plurality of vessels 12 may be used and configured in series so that wastewater entering the first vessel 12 exits first vessel 12 and then enters second vessel 12 for further treatment, and exits second vessel 12 and then enters third vessel 12 for final treatment. The treated water exiting third vessel 12 may be disposed of or otherwise reused. Alternatively, vessels 12 could be configured in parallel arrangement so that wastewater enters each of vessels 12 with treated water exiting each of vessels 12 for disposal or reuse. Again, it is to be understood that any number of vessels 12 may be configured as part of the system 10 and in a variety of arrangements (e.g., in series, parallel, or combination thereof).

Again with reference to FIGS. 4 and 5, skid 36 may include a frame assembly 74 that includes bottom plate 76, vertical support beams 78, and lateral supports 80 interconnecting beams 78. Upper end 82 of beams 78 may contain lifting eyelets 84 for hoisting skid 36. As seen in FIG. 5, skid 36 has been hoisted on trailer 86 for transport.

System 10 may be used on a land or offshore platforms (e.g., land drilling or production rigs, offshore production platforms, floating vessels, offshore drilling rigs, etc.). System 10 is designed for easy mobility and set up. In operation, canisters 40 are each filled with bulk media 42 depending on the type and amount of impurities in the wastewater. Each canister 40 is then inserted into compartment 26 of vessel 12. Seal means 56 form a fluid tight seal between each canister 40 and inner wall 28 of vessel 12. Seal means 56 also form a fluid tight seal between adjacent canisters 40. Wastewater is pumped under pressure in vessel 12 through inlet portal 20. Wastewater then enters first canister 40 in the series where the wastewater intermixes and comes into contact with media 42. The treated wastewater in first canister 40 is then transmitted under pressure into second canister 40 in the series where the treated wastewater undergoes further treatment due to intermixing and/or contact with media 42 in second canister 40. In like fashion the treated water flows through the remaining canisters 40 in the series where the treated wastewater undergoes additional treatment in each of the remaining canisters 40 in vessel 12 until the treated water exits vessel 12 through outlet portal 24. The treated water may then be sent through another system 10, back through the same system 10, or to a container or the like for storage. The treated water may then be disposed or reused if treatment is completed.

While preferred embodiments of the present invention have been described, it is to be understood that the embodiments described are illustrative only and that the scope of the invention is to be defined solely by the appended claims when accorded a full range of equivalents, many variations and modifications naturally occurring to those skilled in the art from a perusal hereof.

What is claimed is:

1. A wastewater treatment system comprising:
a vessel having an inlet end, an outlet end, and an inner compartment with an inner wall; and
a plurality of media canisters housed within said inner compartment of said vessel and in linear fluid communication with each other, each of said plurality of media canisters containing a bulk treatment media and including a seal means forming a fluid tight seal between said media canister and said inner wall of said vessel.

2. The wastewater treatment system of claim 1, wherein said inlet end of said vessel includes a detachable inlet end cap with an inlet portal to provide fluid communication of a wastewater from an external wastewater source to said inner compartment of said vessel for treatment by said bulk treatment media contained within each of said plurality of media canisters to produce a treated water.

3. The wastewater treatment system of claim 2, wherein said outlet end of said vessel includes a detachable outlet cap with an outlet portal to provide fluid communication of said treated water from said inner compartment of said vessel to an area external to said vessel for disposal or other use.

4. The wastewater treatment system of claim 1, wherein said vessel includes an air vent for the passage of air from said inner compartment to an atmosphere external to said vessel.

5. The wastewater treatment system of claim 4, wherein said air vent is positioned on a top side of said vessel.

6. The wastewater treatment system of claim 5, wherein said air vent is positioned at said inlet end thereof.

7. The wastewater treatment system of claim 1, wherein said vessel includes a drain portal for passage of a contaminant liquid from said inner compartment of said vessel to a collection area external to said vessel.

8. The wastewater treatment system of claim 7, wherein said drain portal is positioned on a bottom side of said vessel.

9. The wastewater treatment system of claim 8, wherein said drain portal is positioned on said bottom side of said vessel at said outlet end thereof.

10. The wastewater treatment system of claim 1, wherein each of said plurality of media canisters includes a first end section having a first detachable end plate and a second end section having a second detachable end plate.

11. The wastewater treatment system of claim 10, wherein said first and second end plates each includes a seal means, said seal means forming a seal between said media canister and said inner wall of said vessel.

12. The wastewater treatment system of claim 11, wherein said first and second end plates each includes a handling means, said handling means facilitating the manipulation of said media canister into and out of said inner compartment of said vessel.

13. The wastewater treatment system of claim 11, wherein said first and second end plates each includes a screen support plate with one or more openings and a perforated screen covering said one or more openings, said one or more openings permitting fluid communication into and out of said media canister while maintaining said bulk material therein.

14. The wastewater treatment system of claim 1, wherein said bulk treatment media contained within each of said plurality of media canisters treats a wastewater to remove or neutralize one or more contaminants therein.

15. The wastewater treatment system of claim 14, wherein said bulk treatment media is selected from the group consisting of a carbon, a flocculant, a coagulant, an organophillic clay media, and a solidification agent.

16. The wastewater treatment system of claim 1, wherein each of said plurality of media canisters includes a skid to facilitate the insertion and removal of said media canister from said inner compartment of said vessel.

17. A wastewater treatment system comprising:
a plurality of vessels, each of said plurality of vessels including an inlet end, an outlet end, an inner compartment with an inner wall, and a plurality of media canisters housed within said inner compartment in linear fluid communication with each other, each of said plurality of media canisters containing a bulk treatment media and including a seal means forming a fluid tight seal between said media canister and said inner wall of said vessel; and
a skid to which said plurality of vessels are detachably or fixedly attached.

18. The wastewater treatment system of claim 17, further comprising:
a pump for pumping a wastewater through one or more of said plurality of vessels.

19. The wastewater treatment system of claim 17, wherein said plurality of vessels are in fluid communication with each other.

20. The wastewater treatment system of claim 17, wherein said skid includes a frame assembly having a bottom plate, at least four vertical support beams and one or more lateral supports interconnecting two of said vertical support beams.

21. A method of treating wastewater, comprising the steps of:
a) providing a wastewater treatment system, said system comprising: a vessel having an inlet end, an outlet end, and an inner compartment with an inner wall; and a plurality of media canisters housed within said inner compartment of said vessel and in linear fluid communication with each other, each of said plurality of media canisters containing a bulk treatment media and including a seal means forming a fluid tight seal between said media canister and said inner wall of said vessel;
b) pumping a wastewater under pressure into said inlet end of said vessel;
c) causing said wastewater to flow through each of said plurality of media canisters, said bulk treatment media contained within each of said plurality of media canisters treating said wastewater to produce a treated water;
d) causing said treated water to exit said outlet end of said vessel.

22. The method of claim 21, further comprising the steps of:
e) causing said treated water exiting said outlet end of said vessel to reenter said inlet end of said vessel for further treatment.

23. The method of claim 21, further comprising the steps of:
e) providing one or more additional wastewater treatment systems, each additional system comprising: a vessel having an inlet end, an outlet end, and an inner compartment with an inner wall; and a plurality of media canisters housed within said inner compartment of said vessel and in linear fluid communication with each other, each of said plurality of media canisters containing a bulk treatment media and including a seal means forming a fluid tight seal between said media canister and said inner wall of said vessel;
f) causing said treated water exiting said outlet end of said vessel of the system provided in step (a) to enter said inlet end of said vessel of one or more of said additional systems for further treatment to produce a further treated water; and
g) causing said further treated water to exit said outlet end of said vessel of said one or more of said additional systems.

24. The method of claim 23, further comprising the steps of:
h) causing said further treated water exiting said outlet end of said vessel of one or more of said additional systems in step (g) to enter said inlet end of said vessel of another of said additional systems for further treatment.

25. The method of claim 21, further comprising the step of:
e) storing said treated water exiting said outlet end of said vessel for disposal or reuse.
